(19) United States
(12) Patent Application Publication
(10) Pub. No.: US 2026/0110532 A1
(43) Pub. Date: Apr. 23, 2026

(54) OPTICAL MEASUREMENT WITH AXIS MOVEMENTS

(71) Applicant: Klingelnberg GmbH, Hückeswagen (DE)

(72) Inventor: Benjamin Merkert, Wipperfürth (DE)

(21) Appl. No.: 19/365,697

(22) Filed: Oct. 22, 2025

(30) Foreign Application Priority Data
Oct. 23, 2024 (EP) 24208454.9

(51) Int. Cl. G01B 11/24; G01B 11/00

(52) U.S. Cl. CPC G01B 11/2416; G01B 11/005

(57) ABSTRACT

A method including the following method steps optical measurement of a gear geometry of a gearing using an optical measuring device of a coordinate measuring machine, wherein measuring points with coordinate measurement values are recorded, wherein during the recording of the measuring points, a relative movement of the optical measuring device relative to the gearing to be measured is performed. The relative movement has an oscillation and/or a speed of the relative movement of up to 100 mm/s and/or an acceleration of the relative movement of up to 300 mm/s².

### CROSS-REFERENCE TO RELATED APPLICATIONS

This application claims the benefit of European patent application no. 24208454.9, filed on 23 Oct. 2024, the disclosure of which is incorporated herein by reference in its entirety.

### TECHNICAL FIELD

The present disclosure relates to a method for optically measuring the gear geometry of a gearing using an optical measuring device of a coordinate measuring machine, wherein measuring points are recorded with coordinate measurement values, wherein during the recording of the measuring points, a relative movement of the optical measuring device is performed with respect to the gear geometry to be measured. The disclosure also relates to a coordinate measuring machine for gear measurement.

### BACKGROUND

Optical measuring devices enable reduced measuring times in gear measurement, since, in comparison to tactile measuring systems, the time-consuming traversing and feed movements of the measuring probe are eliminated during measurement. This is because, due to the nature of the system, a measuring probe can only detect and record as a measuring point the position that has actually been approached in physical contact with a tooth flank of a gearing to be measured. In contrast, optical measuring systems can record measured values at a distance from the gearing to be measured, while the gearing to be measured is rotated in front of the stationary optical measuring device, for example.

Optical measurement at a distance from the gearing to be measured has the disadvantage that the geometry of classic gearings, in particular their tooth shape, such as that of spur gears or bevel gears, presents very unfavorable conditions for optical measurement. This can lead to shadowing, particularly in the tooth root area, which impairs the quality of the optical measurement. Furthermore, different angles of an optical axis of the measuring system to the surface to be measured result for different measuring points along a tooth flank to be measured, so that the geometric conditions of the optical image along a tooth flank change and unfavorable angles for optical measurement result.

### SUMMARY

Against this background, the present disclosure is based on the technical problem of specifying a method for optically measuring the gear geometry of a gearing of the type mentioned at the outset, which enables improved optical measurement. Furthermore, a coordinate measuring machine for carrying out such a method is to be specified.

According to a first aspect, the disclosure relates to a method comprising the following method steps: optical measurement of a gear geometry of a gearing using an optical measuring device of a coordinate measuring machine, wherein measuring points are recorded with coordinate measurement values, wherein during the recording of the measuring points, a relative movement of the optical measuring device is performed with respect to the gearing to be measured. The method is characterized in that the relative movement has an oscillation and/or a speed of the relative movement is up to 100 mm/s and/or an acceleration of the relative movement is up to 300 mm/s².

The fast and/or oscillating movement of the optical measuring device enables more efficient optical measurement to be achieved.

In particular, shadows can be avoided, surface structures can be detected, and component boundaries or the macroscopic dimensions of the component having the gearing can be determined. Furthermore, gaps in detected point clouds of the coordinate measurement values, which would arise without a fast and/or oscillating relative movement of the optical measuring device, can be closed.

The measurement of the gear geometry can include an evaluation of the coordinate measurement values, e.g., the determination of gear parameters such as profile shape, flank shape, number of teeth, outer diameter, tooth pitch, gap width, module, helix angle, spiral angle, tip cone, foot cone, tip relief, foot relief, end relief, profile crowning, width crowning, or the like.

The relative movement may include oscillation. Oscillation enables, in particular, scanning of surface areas in order to detect surface structures such as waviness or roughness.

Alternatively or additionally, the oscillation enables the optical measurement to be adapted to the respective measurement task in order to improve the measurement result and to increase the area of the surface of a respective tooth flank covered by the measurement overall.

The oscillation may have a frequency greater than or equal to 0.5 Hz and less than or equal to 10 Hz.

The oscillation can have a frequency greater than or equal to 1 Hz and less than or equal to 5 Hz.

The oscillation is, in particular, a controlled movement that is performed by means of controlled axis drives of the coordinate measuring machine. In particular, the oscillation is not generated by a vibration exciter or vibration actuator separate from the axis drives.

In particular, the oscillation is part of a CNC-controlled movement or CNC axis kinematics as part of a measuring sequence of the gearing to be measured.

The oscillation can have an amplitude greater than or equal to 1 mm and less than or equal to 50 mm.

The oscillation may have an amplitude greater than or equal to 2 mm and less than or equal to 30 mm.

All of the above numerical values are to be understood as examples and, depending on the measurement task or the geometry of the gearing to be measured, may also be selected outside the specified ranges in accordance with alternative designs.

It may be provided that a frequency and/or amplitude of the oscillation is kept constant for a predetermined measurement sequence of the gearing for teeth to be measured in succession. This means that the teeth of a gearing to be measured can be optically scanned with the same frequency and/or amplitude of the relative movement.

The oscillation can be adapted to the geometry of the gearing. For example, oscillation can take place in the tooth height direction so that the optical measuring device follows the peaks and valleys of the tooth profile, i.e., the profile of the gearing specified by the teeth and gaps. Alternatively or additionally, oscillation can take place in the tooth thickness direction and/or in the tooth width direction.

The optical measuring device may have an optical distance sensor, in particular a confocal chromatic distance sensor.

The optical distance sensor may be a point sensor for optical distance measurement.

In particular, individual measuring points can be measured one after the other by the point sensor. Each individual measuring point can be detected independently and separately from other measuring points by means of the point sensor. This means that, in particular, it may be possible to detect a single measuring point without simultaneously detecting other measuring points by means of the point sensor. Three spatial coordinates, i.e., coordinate measurement values, can be assigned to each individual measuring point, e.g., an x-value, a y-value, and a z-value in a Cartesian coordinate system x-y-z.

It may be provided that a focus diameter of the optical distance sensor is 50 micrometers or less, in particular 20 micrometers or less.

It may be provided that the point sensor for optical distance measurement has a depth resolution.

For example, as viewed along an optical axis of the point sensor, a depth, i.e., a distance of the optically scanned surface or tooth flank along the optical axis can be measured in a predetermined coordinate system, e.g., a distance to an origin of the predetermined coordinate system or to another geometric reference, such as the position of a lens or the like. It may be provided that the distance measurement is performed one-dimensionally along an optical axis and three-dimensional measured values are calculated based on the position of the optical measuring system.

For example, as viewed along an optical axis of the point sensor, a depth can be measured in a depth measurement range of a few centimeters or a few millimeters, or in a depth measurement range of less than one millimeter along the optical axis, i.e., a distance of the optically scanned surface or tooth flank along the optical axis in a predetermined coordinate system, e.g., a distance to an origin of the predetermined coordinate system or to another geometric reference, such as the position of a lens or the like. Based on the distance information from the point sensor, a three-dimensional measuring point can be generated in particular, wherein information on the axis positions of the coordinate measuring machine carrying the optical point sensor can be taken into account. It may be provided that the distance measurement is performed one-dimensionally along an optical axis and three-dimensional measured values are calculated based on the position of the optical distance sensor.

It may be provided that the coordinate measuring machine has two or more point sensors for optical distance measurement.

It may be provided that point sensors are arranged along a line in succession or in a grid-like pattern in rows and columns. Each of the point sensors is therefore set up in particular in the manner described above for optical distance measurement and has in particular a depth measurement range with a depth resolution along an optical axis. The point sensors can record measured values simultaneously.

In particular, the coordinate measuring machine does not have a camera for optical measurement of a workpiece geometry. In particular, the coordinate measuring machine does not have a camera for two-dimensional imaging.

It may be provided that, in particular, no camera is provided for detecting measuring points by image or pixel analysis. In particular, it may be provided that no camera is provided for two-dimensional imaging for detecting measuring points by image or pixel analysis.

The oscillation can be adapted to a measuring range of the optical distance sensor. If, for example, the tooth height of a respective tooth of the gearing exceeds an available depth measuring range of the optical distance sensor, an oscillation of the optical distance sensor can take place in the tooth height direction while the gearing rotates about its axis of rotation. In particular, the oscillation can be coupled to the rotation of the gearing in such a way that the frequency of the oscillation of the optical distance sensor corresponds to the rotational speed of the gearing multiplied by the number of teeth.

According to one design of the method, it may be provided that a speed of the relative movement is at least temporarily greater than 10 mm/s, in particular at least temporarily greater than 20 mm/s, and further in particular at least temporarily greater than 50 mm/s.

According to one design of the method, it may be provided that the acceleration of the relative movement is at least temporarily greater than 10 mm/s², in particular at least temporarily greater than 50 mm/s², and further in particular at least temporarily greater than 100 mm/s².

The coordinate measurements can be determined taking into account the speed of the relative movement. Fast relative movements in particular can lead to measurement results being distorted. Software-based compensation can therefore be provided to offset or compensate for measurement deviations resulting from the relative movement of the optical measuring device.

It may be provided that at least one movement component of the relative movement is oriented in a direction perpendicular or inclined to a rotational axis of the gearing.

Alternatively or additionally, it may be provided that at least one movement component of the relative movement may be oriented in a direction parallel to the axis of rotation of the gearing.

The relative movement may be a superimposed movement with movement components in at least two mutually orthogonal spatial directions.

When reference is made to relative movement in the present context, this always refers to a movement of the optical measuring device. For this purpose, the optical measuring device can be carried by controlled machine axes of the coordinate measuring machine and be movable in at least two spatial directions, in particular in three spatial directions.

In particular, the optical measuring device can be moved in a translational manner in three mutually orthogonal spatial directions by means of controlled machine axes, wherein the movements can be superimposed on each other. In particular, the optical measuring device can be pivoted around one, two, or three axes by means of controlled machine axes.

It may be provided that the gearing is moved relative to the optical measuring device during the measurement, wherein this movement of the gearing is referred to here as an additional movement.

For example, the gearing can be rotated about a rotational axis during measurement. For this purpose, the gearing can be held, for example, on a rotary axis or a rotary table of the coordinate measuring machine.

According to one design of the method, it may be provided that the gearing is rotated at a constant rotational speed about the axis of rotation during the detection of the measuring points.

It may be provided that an additional rotational movement of the gearing, i.e., a rotational speed of the gearing during the detection of the measuring points, is coupled to the relative movement of the optical measuring device during the detection of the measuring points. In particular, it may be provided that an oscillation of the optical measuring device is set in a predetermined ratio to the number of teeth and the rotational speed of the gearing to be measured.

According to a second aspect, the disclosure relates to a coordinate measuring machine for gear measurement, having controlled machine axes for performing measuring movements, having an optical measuring device for detecting coordinate measurement values, wherein the optical measuring device is movable relative to a gear tooth to be measured by means of the machine axes, wherein the coordinate measuring machine is designed to perform the method according to the disclosure.

### BRIEF DESCRIPTION OF THE DRAWINGS

The disclosure is explained in more detail below with reference to a drawing illustrating an exemplary embodiment. The following figures show schematically:

FIG. 1 shows a coordinate measuring machine according to the disclosure;

FIG. 2 shows a gearing to be measured;

FIG. 3 shows an optical measurement;

FIG. 4 shows another optical measurement;

FIG. 5 shows motion profiles of the machine axes; and

FIG. 6 shows method steps of a method according to the disclosure.

### DETAILED DESCRIPTION OF THE DRAWINGS

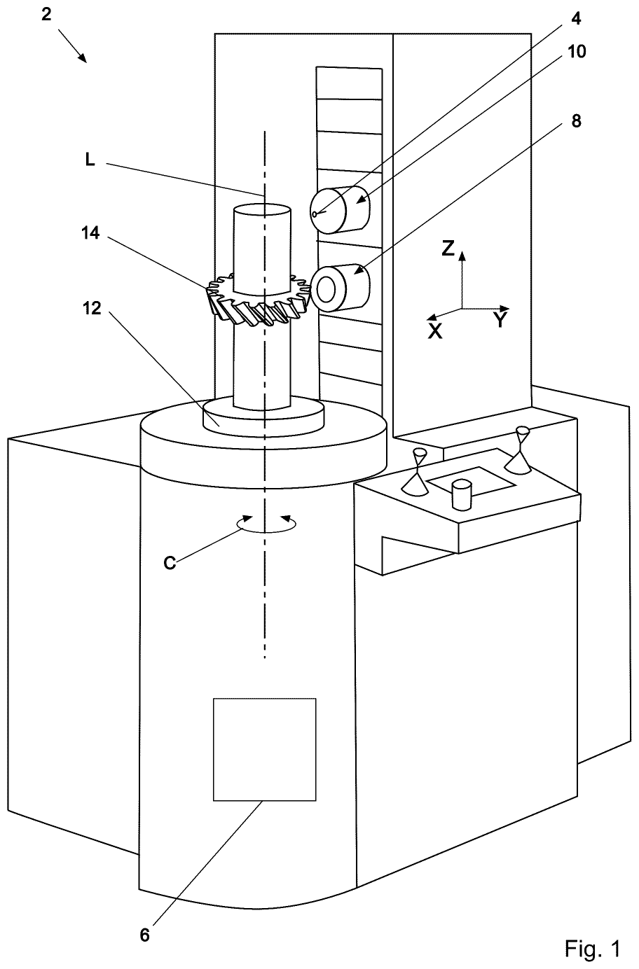

FIG. 1 shows a coordinate measuring machine 2 according to the disclosure for gear measurement. The coordinate measuring machine 2 has controlled, driven machine axes in a known manner for performing superimposed measuring movements along the Cartesian coordinate axes X, Y, Z and around the axis of rotation C. The coordinate measuring machine 2 therefore has three translational degrees of freedom and one rotational degree of freedom in order to realize a relative movement during a measurement.

The reference signs X, Y, Z, and C can therefore be regarded by way of example and schematically, in addition to the degrees of freedom mentioned, as reference signs for designating three CNC-controlled linear axes X, Y, Z, and a CNC-controlled rotational axis C, i.e., to designate the CNC-controlled machine axes, which can be, for example, three controlled, driven linear axes and one controlled, driven rotational axis.

The coordinate measuring machine 2 has a control and evaluation device 6 for executing measuring sequences and evaluating measurement data.

The coordinate measuring machine 2 has an optical measuring device 8 for optically detecting coordinate measurement values. The coordinate measuring machine 2 also has a tactile measuring device 10 with a measuring probe 4.

A rotary table 12 is used to hold a gearing 14 to be measured.

The optical measuring device 8 can be moved in three spatial directions X, Y, Z relative to the gearing 14 to be measured by means of the machine axes X, Y, Z. The gearing 14 to be measured can be rotated about its longitudinal axis L relative to the optical measuring device 8 by means of the rotary axis C.

The optical measuring device 8 is a confocal chromatic distance sensor.

The coordinate measuring machine 2 is set up to perform a method according to the disclosure described below.

FIG. 2 shows an example of an external helical-toothed spur gear 14 in schematic form. In a known manner, profile lines 20 on tooth flanks 18 of the teeth 16 of the gearing 14 are to be detected. Measured values are to be recorded on each tooth flank 18 both in the direction of the tooth height ZH and the tooth width ZB.

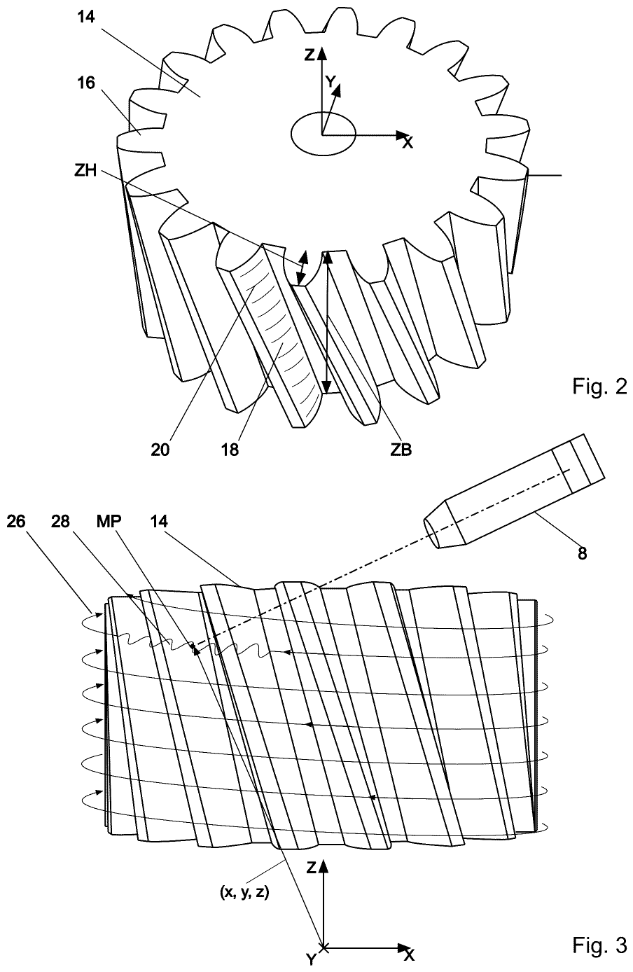

For this purpose, it may be provided that the gear wheel 14 is rotated about the C-axis during the measurement and the optical measuring device 8 is moved in the Z-direction during this time. This superimposed movement results in a measuring spiral 26, as indicated in FIG. 3. In addition, the relative movement of the optical measuring device 8 may exhibit an oscillation in the X direction and/or in the Y direction, so that an oscillating relative movement 28 of the optical measuring device 8 is superimposed on the measuring spiral.

The oscillating relative movement 28 can occur in sections, as indicated in FIG. 3, or can be superimposed along the entire measuring spiral 26.

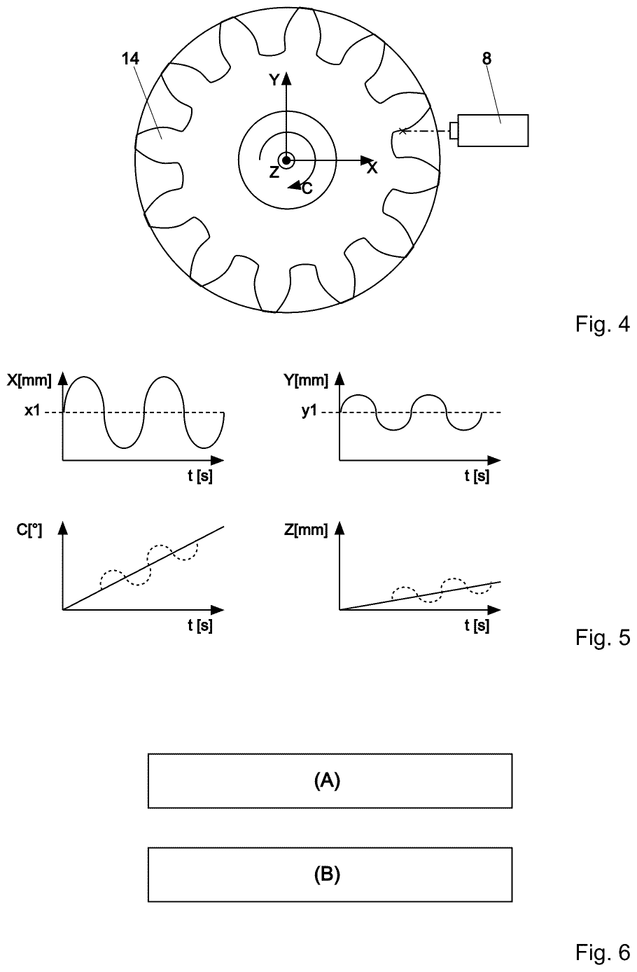

For better comprehensibility of the above embodiments, FIG. 4 and FIG. 5 show the degrees of freedom X, Y, Z, and C and the associated relative movement of the optical measuring device 8 per axis X, Y, Z plotted over time t, as well as the additional rotational movement C of the gearing 14 plotted over time. The curves shown are to be understood as schematic.

As can be seen in FIG. 5, the optical measuring device oscillates in the X direction around a position x1 and in the Y direction around a position y1. It is also possible for there to be pure oscillation in the X direction without oscillation in the Y direction, or vice versa.

The Z-axis and the C-axis are each moved at a constant speed.

According to alternative designs, it may be provided that an oscillation takes place in the Z direction and/or around the C axis. For example, the constant feed movement in the Z direction shown may be superimposed by an oscillation in the Z direction, or the constant rotation around the C axis may be superimposed by an oscillation around the C axis. This is indicated schematically by the dashed lines in the diagrams for Z and C.

The oscillation can be adjusted in such a way that, for example, the oscillation in the X direction is tracked according to the tooth profile of the gearing, i.e., the distance between the optical measuring device and the axis of rotation of the gearing 14 is reduced for measuring in the root area of a respective tooth 16 and increased for measuring in the tip area of a respective tooth 16.

In this way, the course of the oscillation in the X direction can, for example, reproduce the tooth profile of a cycloidal gearing or, optionally, reproduce a compressed or stretched tooth profile of this cycloidal gearing. This applies equally to involute gearings or other profile shapes.

Overall, a method can therefore be specified comprising the following method steps: (A) Optical measurement of the gear geometry of the gearing 14 using the optical measuring device 8 of the coordinate measuring machine 2, wherein measuring points MP with coordinate measurement values x, y, z are recorded; (B) wherein, during the recording of the measuring points MP, a relative movement of the optical measuring device 8 relative to the gearing 14 to be measured is performed.

1. A method including the following steps:
optical measurement of a gear geometry of a gearing using an optical measuring device of a coordinate measuring machine, wherein measuring points with coordinate measurement values are recorded, wherein during the recording of the measuring points, a relative movement of the optical measuring device relative to the gearing to be measured is performed, wherein the relative movement has an oscillation and/or a speed of the relative movement of up to 100 mm/s and/or an acceleration of the relative movement of up to 300 mm/s².

2. The method according to claim 1,
wherein the oscillation has a frequency greater than or equal to 0.5 Hz and less than or equal to 10 Hz, and/or
the oscillation has an amplitude greater than or equal to 1 mm and less than or equal to 50 mm.

3. The method according to claim 1,
wherein the oscillation is adapted to a geometry of the gearing.

4. The method according to claim 1,
wherein the optical measuring device has a distance sensor.

5. The method according to claim 5,
wherein the oscillation is adapted to a measuring range of the distance sensor.

6. The method according to claim 1,
wherein a speed of the relative movement during the detection of the measuring points is at least temporarily greater than 10 mm/s, and/or
an acceleration of the relative movement during the detection of the measuring points is at least temporarily greater than 10 mm/s².

7. The method according to claim 6,
wherein the determination of the coordinate measurement values is carried out taking into account the speed and/or acceleration of the relative movement.

8. The method according to claim 1,
wherein a movement component of the relative movement is oriented in a direction perpendicular or inclined to a rotational axis of the gearing.

9. A coordinate measuring machine for gear measurement comprising:
controlled machine axes for performing measuring movements,
an optical measuring device for detecting coordinate measurement values,
wherein the optical measuring device is movable relative to a gearing to be measured using the machine axes,
wherein the coordinate measuring machine is designed to perform the method according to claim 1.
